(19) United States
(12) Patent Application Publication
(10) Pub. No.: US 2015/0089364 A1
(43) Pub. Date: Mar. 26, 2015

(54) INITIATING A HELP FEATURE

(71) Applicants: Jonathan Meller, Porto Alegre Rio Grande Do Sul (BR); Wagner Ferreira Vernier, Porto Alegre Rio Grande Do Sul (BR); Gomes Marcelo de Oliveira, Porto Alegre Rio Grande Do Sul (BR); Victor Helfensteller Dos Santos, Porto Alegre Rio Grande Do Sul (BR); Alon Mei-Raz, Rishon-Le-Zion (BR)

(72) Inventors: Jonathan Meller, Porto Alegre Rio Grande Do Sul (BR); Wagner Ferreira Vernier, Porto Alegre Rio Grande Do Sul (BR); Gomes Marcelo de Oliveira, Porto Alegre Rio Grande Do Sul (BR); Victor Helfensteller Dos Santos, Porto Alegre Rio Grande Do Sul (BR); Alon Mei-Raz, Rishon-Le-Zion (BR)

(21) Appl. No.: 14/394,923

(22) PCT Filed: Jul. 24, 2012
(86) PCT No.: PCT/US2012/047923

§ 371 Date: Oct. 16, 2014

(51) Int. Cl. G06F 9/44; G06F 3/0488

(52) U.S. Cl. CPC G06F 9/4446; G06F 3/0488
USPC 715/708

(57) ABSTRACT

A method for initiating a help feature includes detecting and making a first determination as to whether a first interaction with a surface associated with a user interface matches a predetermined first gesture. Following a positive first determination, a second interaction is detected and a second determination is made as to whether a second interaction with the surface matches a predetermined second gesture. Following a positive second determination, one of a plurality of controls presented in the user interface that corresponds to the second interaction is identified. A help feature corresponding to the identified control is caused to be displayed.

### BACKGROUND

Interacting with a new application or an application with new features is not always intuitive. An application's user interface can include any number of controls through which the user interacts. The controls can be used to display information to the user and to accept user input. Such input, for example, can be the selection of a radio button or check box or the inputting of text. Other input can include the section of a command button designed to case the application to take a designated action. The function of any given control may not always be clear. Various techniques for helping the user identify the purpose of a user interface control developed over time. One technique includes placing a help link next to the control. Another includes adding pop up explanations that appear when the mouse cursor hovers over a given control.

### DRAWINGS

FIGS. 1-5 depict screen views of user interfaced presenting collaboration content according to an example.

FIG. 6 depicts a system according to an example.

FIG. 7 depicts a table mapping a user interface location to a control and to help data for that control according to an example.

FIG. 8 is a block diagram depicting a memory resource and a processing resource according to an example.

FIG. 9 is a flow diagram depicting steps taken to implement an example.

### DETAILED DESCRIPTION

### Introduction:

Various embodiments described below were developed to provide an intuitive way for a user to initiate a help feature with respect to a control being displayed in a user interface. The user interface serves as a common point of contact between a user and an application. A positive user experience is influenced heavily by that interface—the more intuitive the better. Interaction is achieved through user interface controls such as text fields, menus, check boxes, radio buttons, command buttons, and the like. To allow a user to fully interact, a complex application can include many such controls spread across a display. Thus, it can be difficult at times for the user to fully comprehend the functions available and how to interact with the controls to achieve a desired result. A less complex application may rely on a more elegant, visually appealing user interface. This too can leave a user guessing as to the true nature of a given control.

One approach to help a user understand an interface and its control has been to provide links adjacent a control that the user can select and access a help feature for that control. For complex applications, often there is not room to display such links in a visually appealing manner if at all. Further, adding such links to a more minimalistic interface adds clutter diminishing the intended visual appeal. Another approach has been to add a hover feature such that when the user positions a cursor over a control, a pop-up widow appears displaying information concerning the control. Such an approach is loses its effectiveness with a touch screen interface that does not rely on the use of a cursor controlled by a pointing device such as a mouse.

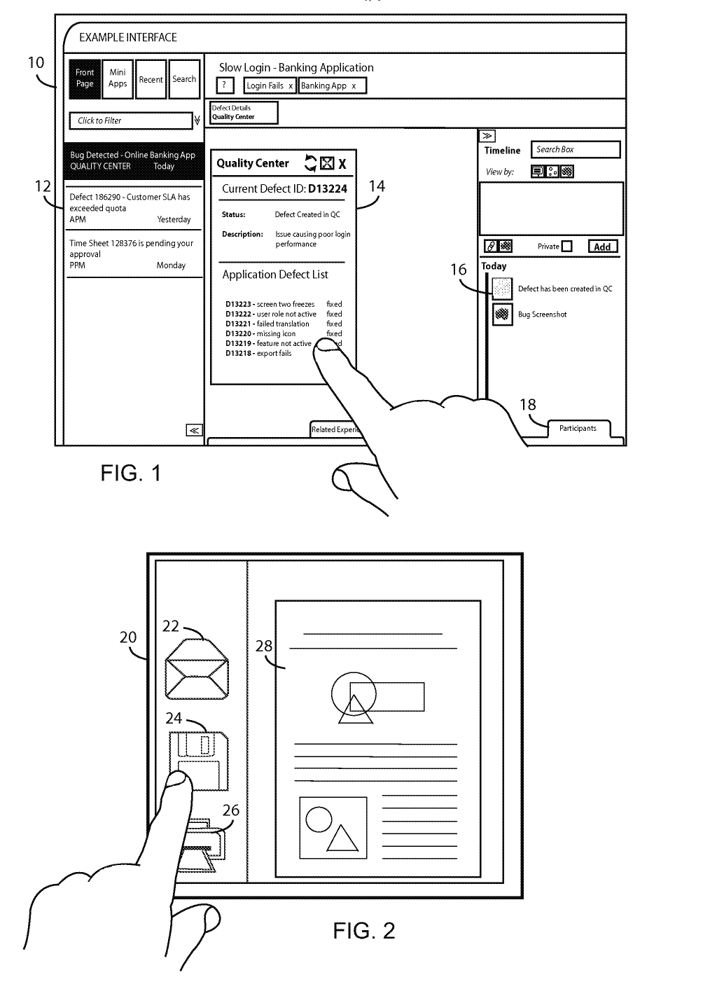

The approach presented herein involves the use of an intuitive two part gesture such as a question mark. The question mark is an intuitive symbol for help and traditionally includes two parts—a hook and a dot. In an example implementation, the user, via a swiping motion, gestures the hook portion of question mark on a touch screen displaying the user interface. Within a time window, the user then gestures the dot by tapping or touching the control in question to initiate a help feature for that control. It is noted that the dot portion need not align with the hook portion. It is also noted that other two part gestures may be used. In another example, the user may gesture a circle around the control in question and then tap the control in the center. In yet another example, the user may swipe a Z pattern and then tap a corresponding control. Illustrative examples are described below with respect to FIGS. 1-4.

The following description is broken into sections. The first, labeled “Illustrative Example,” presents an example in which collaborative content is personalized and presented to participants in a collaborative experience. The second section, labeled “Environment,” describes an environment in which various embodiments may be implemented. The third section, labeled “Components,” describes examples of various physical and logical components for implementing various embodiments. The fourth section, labeled as “Operation,” describes steps taken to implement various embodiments.

### Illustrative Examples

FIGS. 1-2 depict screen views of example user interfaces. FIG. 1 depicts a touchscreen displaying a relatively complex user interface 10 with various controls 12-16. At first glance, it may not clear the purpose of each control or how the user is to interact with interface 10 to achieve a desired goal. Adding help links to controls 12-18 adds visual clutter and adding hover functionality does not work well with the touch screen interface.

FIG. 2 depicts a touch screen displaying a relatively simple user interface 20 with various controls 22-28. While the icons intuitively identify a function, there may be additional functions that are not so clear. For example, control 26 relates to printing, but it is not readily apparent how a user might select a desired printer. As with FIG. 1, adding help links to controls 22-28 adds visual clutter and adding hover functionality does not work well with the touch screen interface.

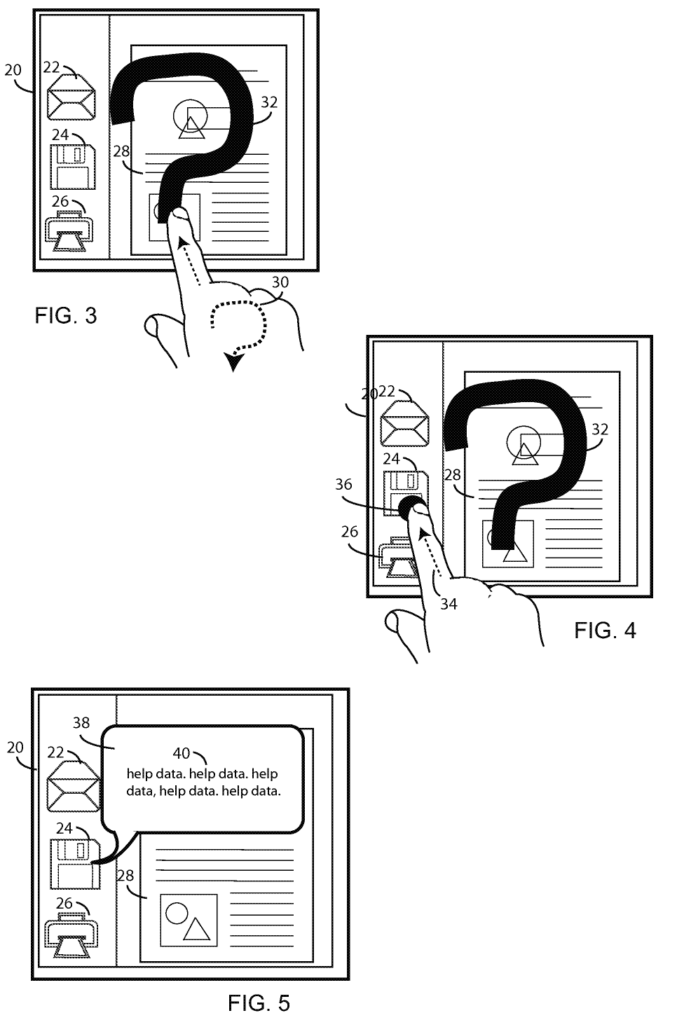

FIGS. 3-5 depict an example in which a user has initiated a help feature with respect to control 24 of user interface 20. Starting with FIG. 3, the user has interacted with a touch screen surface displaying user interface 20. That interaction 30 involves swiping the surface in the shape of hook 32. It is noted that hook 32 may, but need not, be visible. Furthermore, hook 32 may be oriented in any fashion. In FIG. 4, the user has again interacted with the surface. This second interaction 34 involves tapping the surface at a location corresponding to control 24. This tap is represented by dot 36. Intuitively, dot 36 represents the dot portion of a question mark. It is noted however, that dot 36 need not be positioned on the surface in any particular location with respect to hook 32. By tapping control 24, help feature 38 containing help data 40 is displayed in FIG. 5. Here, help data corresponds to control 24. While help data 40 is shown as text, help data 40 may allow for user interaction through menus, links, and other interactive controls.

### Components:

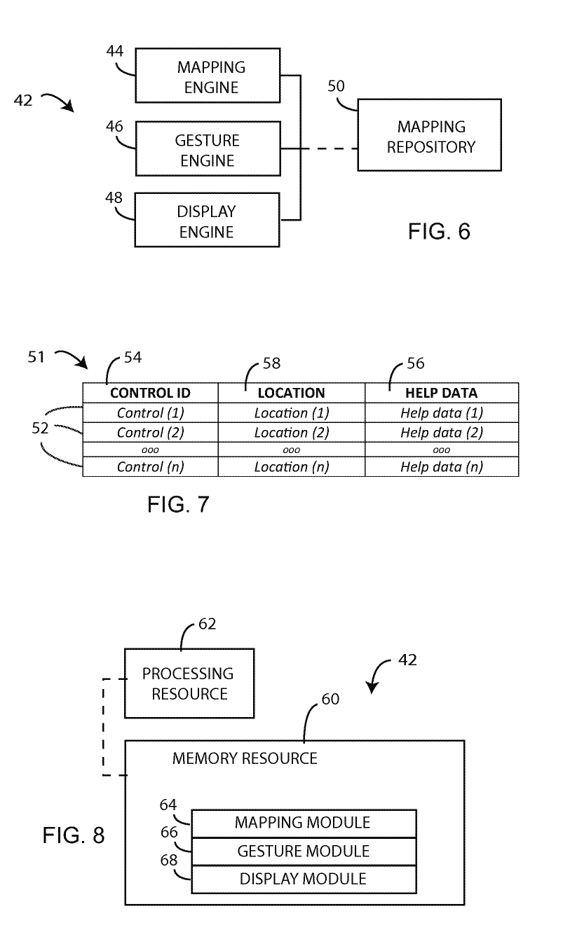

FIGS. 6-8 depict examples of physical and logical components for implementing various embodiments. FIG. 6 depicts help system 42 for initiating a help feature. In the example of FIG. 6, system 42 includes mapping engine 44, gesture engine 46, and display engine 48. Also shown is mapping repository 50 with which system 42 may interact. Mapping repository 50 represents generally memory storing data for use by system 42. An example data structure 51 stored by mapping repository 50 is described below with respect to FIG. 7.

Mapping engine 44 represents generally a combination of hardware and programming configured to map each of a plurality of controls of a user interface to help data relevant to that control. Thus, when the control is selected (via a dot action for example), help data mapped to that control can be identified. In some implementations, mapping engine 44 may also be responsible for mapping each control to a location of a surface associated with a display of that user interface. That surface, for example, can be a touch screen used to display the user interface. In this manner, a particular control can be identified by detecting a location of the surface acceded upon by a user.

In performing its function, mapping engine 44 may maintain or otherwise utilize data structure 51 of FIG. 7. Data structure 51, in this example, includes series of entries 52 each corresponding to a control of a user interface. Each entry 52 includes data in control ID field 54, help data field 56. Data in control ID field 54 identifies a particular control of the user interface. Data in help data field 58 includes or identifies help data for the control identified in control ID field 54. The help data can include any information concerning the corresponding control. Such information can include text as well as interactive controls that, for example, may allow a user to set parameters that relate to the control. As an example, a control may be a command button to initiate a save operation. The help data for such a control may include other controls for selecting a default save location or format as well as a textual explanation. Each entry 52 may also include data in location field 58 that identifies a relative location of a corresponding control within the user interface as displayed. That location then can correspond to a location on a surface of a touch screen displaying the user interface.

Referring back to FIG. 6, gesture engine 46 represents generally a combination of hardware and programming configured to identify a user's interaction with the surface and to determine if the interaction matches a predetermined first gesture followed by a predetermined second gesture. Again, the surface may be a touch screen displaying the user interface. The predetermined first gesture can include a hook motion and the predetermined second gesture can include a dot action. The hook motion and the dot action are indicative of a question mark. However, there is no requirement as to the relative position of the dot action with respect to the hook motion. In other words, the dot action need not align with the hook motion to form a question mark as would be the case with a question mark used in printed material.

Where gesture engine 46 positively determines that the interaction matches the first gesture followed by the second, mapping engine 44 is then responsible for identifying one of the plurality of controls that corresponds to the second gesture. The corresponding control, for example, can be a control selected by the second gesture. The corresponding control may be one of the plurality of controls of the user interface mapped to a location of the surface that corresponds to the second gesture. Where, for example, the second gesture is a dot action, the identified control is a control selected by or positioned nearest a location of the dot action. In other words, it is the control being tapped by the user. In one example, an operating system of the device displaying the user interface or the application responsible for the user interface communicates data in response to the second gesture. Here, that data includes an identification of the selected control. In another example, gesture engine 46 detects the surface location of the dot action and reports that location to mapping engine 44. Mapping engine 44 then uses the location to find a corresponding entry 52 in data structure 51 of FIG. 7. From that entry 52, mapping engine 44 identifies the control.

Display engine 48 represents generally a combination of hardware and programming configured to cause a display of the help data associated with the identified control. In performing its function, display engine 48 may access data structure 51 and obtain help data included in or identified by entry 52 for the identified control. Display engine 48 may cause a display by directly interacting and controlling the display device. Display engine 48 may instead cause a display by communicating data indicative of the content to be displayed.

To reiterate, the user's interaction can includes a first interaction and a second interaction. Gesture engine 46 can then be responsible for detecting if the first interaction matches a hook motion and if the second interaction matches the dot action. Gesture engine 46 may be further responsible for determining whether the second interaction occurred within a predetermined time of the first interaction. The predetermined time is a threshold set to help ensure that the first and second interactions were a deliberate attempt to initiate the help feature. If the second interaction occurred outside the threshold, then no further action is taken by mapping engine 44 or display engine 48.

In foregoing discussion, various components were described as combinations of hardware and programming. Such components may be implemented in a number of fashions. Looking at FIG. 8, the programming may be processor executable instructions stored on tangible memory resource 60 and the hardware may include processing resource 62 for executing those instructions. Thus memory resource 60 can be said to store program instructions that when executed by processor resource 62 implement system 42 of FIG. 6.

Memory resource 60 represents generally any number of memory components capable of storing instructions that can be executed by processing resource. Memory resource may be integrated in a single device or distributed across devices. Likewise processing resource 62 represents any number of processors capable of executing instructions stored by memory resource. Processing resource 62 may be integrated in a single device or distributed across devices. Further, memory resource 60 may be fully or partially integrated in the same device as processing resource 62 or it may be separate but accessible to that device and processing resource 62. Thus, it is noted that system 42 may be implemented on a user device, on a server device or collection of servicer devices, or on a combination of the user device and the server device or devices.

In one example, the program instructions can be part of an installation package that when installed can be executed by processing resource 62 to implement system 42. In this case, memory resource 60 may be a portable medium such as a CD, DVD, or flash drive or a memory maintained by a server from which the installation package can be downloaded and installed. in another example, the program instructions may be part of an application or applications already installed. Here, memory resource 60 can include integrated memory such as a hard drive, solid state drive, or the like.

In FIG. 8, the executable program instructions stored in memory resource 60 are depicted as mapping module 64, gesture module 66, and display module 68. Mapping module 64 represents program instructions that, when executed, cause processing resource 62 to implement mapping engine 44 of FIG. 6. Gesture module 66 represents program instructions that when executed cause the implementation of gesture engine 46. Likewise, display module 68 represents program instructions that when executed cause the implementation of display engine 48.

### Operation:

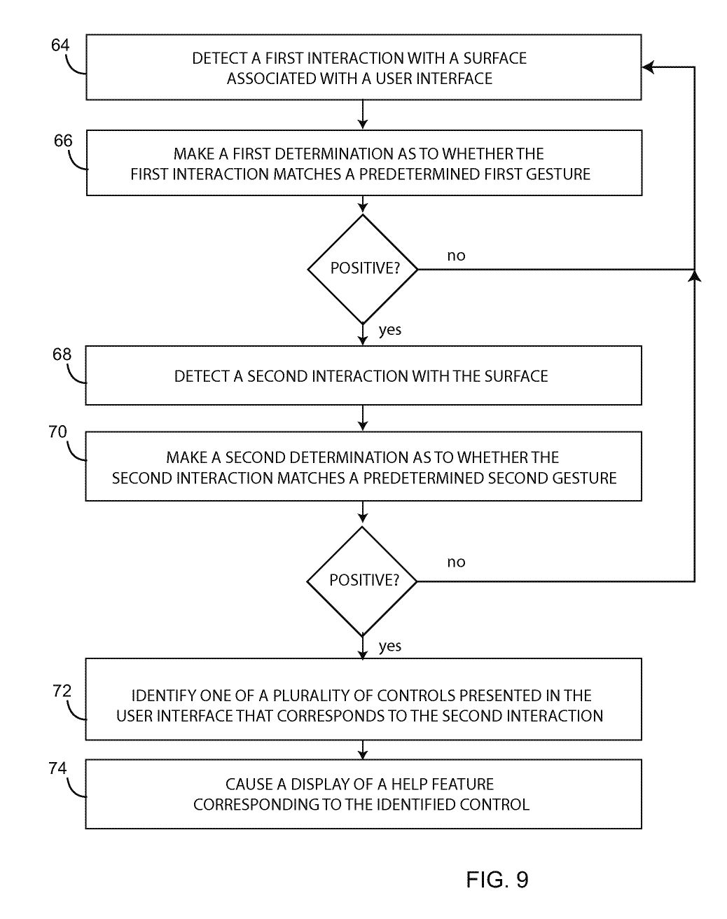

FIG. 9 is a flow diagram of steps taken to implement a method for initiating a help feature. In discussing FIG. 8, reference may be made to the screen views of FIGS. 3-5 and components depicted in FIGS. 6-8. Such reference is made to provide contextual examples only and not to limit the manner in which the method depicted by FIG. 9 may be implemented.

Initially, a first interaction with a surface associated with a user interface is detected (step 64). A first determination is then made as to whether the first interaction matches a first predetermined gesture (step 66). The first gesture, for example may be a hook motion. Upon a negative first determination the process loops back to step 64. Upon a positive determination, the process continues a second interaction with the surface is detected (step 68). Second determination is made as to whether the second interaction matches a predetermined second gesture (step 70). Making the second determination in step 70 can include determining whether the second interaction has occurred and has occurred within a predetermined time of the first interaction. The second gesture may be a dot action. It is again noted that the dot action need not be position with any specific relation to the hook motion. The location of the dot action with respect to the surface is used to identify a particular control for which a help feature is to be displayed. The determination can include a determination as to whether the second interaction resulted in a selection of a control or whether the interaction was with a particular position of the surface. Such a position may for example, be an area of the surface being tapped as a result of the dot action. Upon a negative second determination the process loops back to step 64. Otherwise the process continues on. Referring back to FIG. 6, gesture engine 46 responsible for steps 64-70. FIG. 3 illustrates an example of a hook gesture while FIG. 4 depicts a dot action.

Assuming a positive second determination, one of a plurality of controls presented in the user interface is identified (Step 72). The identified control is a control that corresponds to the second interaction. Such a control, for example, can be a control tapped or otherwise selected via the second interaction. Such a control can be a control mapped to a location of the surface corresponding to the second interaction. For example, the second interaction may be a dot action where a user taps a surface of a touchscreen at the location of a control being displayed as part of the user interface. Referring to FIG. 6, mapping engine 44 may be responsible for step 72. Referring to FIG. 4 as an example, control 24 would be identified in step 72.

A help feature corresponding to the control identified in step 72 is caused to be displayed (step 74). The help feature can in include help data in the form of a textual explanation of the control as well as other interactive controls allowing the user to set parameters with respect to the control. Referring to FIG. 6, display engine 48 may be responsible for implementing step 74. FIG. 5 depicts an example of a help feature being displayed for a selected control.

While not shown, the method depicted in FIG. 9 can also include mapping the plurality of controls of the user interface to the surface. Each control can then be associated with help data relevant to that control. The help feature caused to be displayed in step 74 can then include the help data for the corresponding control. Referring to FIG. 6, mapping engine 44 may responsible for this mapping and may accomplish the task at least in part by maintaining data structure 51 of FIG. 7

### CONCLUSION

FIGS. 1-5 depict example screen views of various user interfaces. The particular layouts and designs of those user interfaces are examples only and intended to depict a sample workflow in which personalized collaboration content is presented to different participants of a collaborative experience. FIGS. 6-8 aid in depicting the architecture, functionality, and operation of various embodiments. In particular, FIGS. 6 and 8 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any non-transitory computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any non-transitory media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 9 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for initiating a help feature, comprising:
detecting and making a first determination as to whether a interaction with a surface associated with a user interface matches a predetermined first gesture;
following a positive first determination, detecting and making a second determination as to whether a second interaction with the, surface matches a predetermined second gesture; and
following a positive second determination, identifying one of a plurality of controls presented in the user interface and causing a display of a help feature corresponding to the identified control, the identified control corresponding to the second interaction.

2. The method of claim 1, wherein:
the predetermined first gesture includes a hook motion and the predetermined second gesture includes a dot action; and
the hook motion and the dot action are indicative of a question mark without requiring a specified relative position of the hook motion and the dot action with respect to one another.

3. The method of claim 2, wherein making a second determination comprises making a second determination as to whether a second interaction with the surface matches a predetermined second gesture and has occurred within a predetermined time of the first interaction.

4. The system of claim 2 wherein:
detecting and making a second determination comprises detecting the second interaction and determining if the second interaction includes a selection of one of the plurality of controls; and
identifying, upon a positive second determination, comprises identifying the selected control and causing a display of a help feature corresponding to the selected control.

5. The method of claim 2, wherein the surface comprises a touch screen on which the user interface is displayed and wherein identifying a control comprises identifying a control positioned nearest a location of the dot action.

6. A system for initiating a help feature, the system comprising a computer readable memory resource having instructions stored thereon that when executed cause a processing resource to implement a system, the system comprising a mapping engine, a gesture engine, and a display engine, wherein:
the gesture engine is configured to identify a user's interaction with a surface associated with a user interface being displayed and to determine if the interaction matches a first predetermined gesture followed by a second predetermined gesture; and
upon a positive determination, the mapping engine is configured to identify one of a plurality of controls being displayed in the user interface that corresponds to the second gesture, and the display engine is configured to cause a display of a help feature corresponding to the identified control.

7. The system of claim 6, wherein:
the predetermined first gesture includes a hook motion and the predetermined second gesture includes a dot action; and
the hook motion and the dot action are indicative of a question mark without requiring a specified relative position of the hook motion and the dot action with respect to one another.

8. The system of claim 7, wherein the user's interaction includes a first interaction and a second interaction, and wherein the gesture engine is configured to determine:
if the first interaction matches the hook motion; and
if the second interaction matches the dot action occurring within a predetermined time of the first interaction.

9. The system of claim 7, wherein the surface comprises a touch screen on which the user interface is displayed and wherein the mapping engine is configured to identify one of a plurality of controls being displayed in the user interface by:
identifying a control positioned on the surface nearest a location of the dot action and link the dot action to the identified control, or
identifying a control selected by the dot action.

10. The system of claim 9, wherein, For each control of the plurality of controls of the user interface, the mapping engine is configured to map that control to help data relevant to that control, and wherein the display engine is configured to cause a display of a help feature by causing a display of the help data mapped to the identified control.

11. The system of claim 6, further comprising the processing resource.

12. A system comprising a mapping engine, a gesture engine, and a display engine, wherein;
the mapping engine is configured, for each of a plurality of controls of a user interface, to map that control to a help data relevant to that control;
the gesture engine is configured to identify a user's interaction with the surface and to determine if the interaction matches a predetermined first gesture followed by a predetermined second gesture;
upon a positive determination by the gesture engine, the mapping engine is configured to identify one of the plurality of controls of the user interface corresponding to the second gesture, and the display engine is configured to cause a display of the help data mapped to the identified control.

13. The system of claim 12, wherein:
the predetermined first gesture includes a hook motion and the predetermined second gesture includes a dot action; and
the hook motion and the dot action are indicative of a question mark without requiring a specified relative position of the hook motion and the dot action with respect to one another.

14. The system of claim 13, wherein the user's interaction includes a first interaction and a second interaction, and wherein the gesture engine is configured to determine:
if the first interaction matches the hook motion; and
if the second interaction matches the dot action occurring within a predetermined time of the first interaction.

15. The system of claim 13, wherein the surface comprises a touch screen on which the user interface is displayed and wherein the mapping engine is configured to identify a control selected as a result of the dot action or positioned nearest a location of the dot action.
